(19) United States
(12) Patent Application Publication
(10) Pub. No.: US 2018/0136314 A1
(43) Pub. Date: May 17, 2018

(54) METHOD AND SYSTEM FOR ANALYZING THE DISTANCE TO AN OBJECT IN AN IMAGE

(71) Applicant: Wheego Electric Cars, Inc., Atlanta, GA (US)

(72) Inventors: Thomas Steven Taylor, Atlanta, GA (US); James Ronald Barfield, JR., Atlanta, GA (US)

(21) Appl. No.: 15/352,275

(22) Filed: Nov. 15, 2016

(51) Int. Cl. G01S 7/484; G06T 7/00; G06K 9/00; G01S 17/08; G01S 17/89; B60R 11/04

(52) U.S. Cl. CPC G01S 7/484; G06T 7/004; B60R 11/04; G01S 17/08; G01S 17/89; G06K 9/00791

(57) ABSTRACT

A controller/application synchronizes a camera's image capture rate with a LIDAR light burst rate. The controller instructs LIDAR to direct bursts within a field of view of the camera. When reflection of energy of a given burst is detected, the controller/application instructs an image recognition/analysis application to determine object characteristics by evaluating pixels of an image corresponding to the given burst within an evaluation range that corresponds to the location to which the burst was directed during an aperture open period when the camera captured the image. The controller may also instruct the LIDAR to determine a distance to an object that reflected the energy of the given burst. Based on the determined distance to the object and object characteristics, the controller may generate a take-action message. The take-action message may include instruction for controlling an autonomous vehicle to avoid interaction with the object that reflected energy of the burst.

### FIELD

Aspects disclosed herein relate to LIDAR and imaging systems, in particular to use of LIDAR to determine the distance to objects detected by an imaging device.

### BACKGROUND

Light-detection and ranging (LIDAR) is an optical remote sensing technology to acquire information of a surrounding environment. Typical operation of the LIDAR system includes illuminating objects in the surrounding environment with light pulses emitted from a light emitter, detecting light scattered by the objects using a light sensor such as photodiode, and determining information about the objects based on the scattered light. The time taken by light pulses to return to the photodiode can be measured, and a distance of the object can then be derived from the measured time.

A Light-detection and ranging (LIDAR) system determines information about an object in a surrounding environment by emitting a light pulse towards the object and detecting the scattered light pulses from the object. A typical LIDAR system includes a light source to emit light as a laser light beam, or laser beam pulses. A LIDAR light source may include a light emitting diodes (LED), a gas laser, a chemical laser, a solid-state laser, or a semiconductor laser diode (“laser diode”), among other possible light types. The light source may include any suitable number of and/or combination of laser devices. For example, the light source may include multiple laser diodes and/or multiple solid-state lasers. The light source may emit light pulses of a particular wavelength, for example, 900 nm and/or in a particular wavelength range. For example, the light source may include at least one laser diode to emit light pulses in a defined wavelength range. Moreover, the light source emits light pulses in a variety of power ranges. However, it will be understood that other light sources can be used, such as those emitting light pulses covering other wavelengths of electromagnetic spectrum and other forms of directional energy.

After exiting the light source, light pulses may be passed through a series of optical elements. These optical elements may shape and/or direct the light pulses. Optical elements may split a light beam into a plurality light beams, which are directed onto a target object and/or area. Further, the light source may reside in a variety of housings and attached to a number of different bases, frames, and platforms associated with the LIDAR system, which platforms may include stationary and mobile platforms such as automated systems or vehicles.

A LIDAR system also typically includes one or more light sensors to receive light pulses scattered from one or more objects in an environment that the light beams/pulses were directed toward. The light sensor detects particular wavelengths/frequencies of light, e.g., ultraviolet, visible, and/or infrared. The light sensor detects light pulses at a particular wavelength and/or wavelength range, as used by the light source. The light sensor may be a photodiode, and typically converts light into a current or voltage signal. Light impinging on sensor causes the sensor to generate charged carriers. When a bias voltage is applied to the light sensor, light pulses drive the voltage beyond a breakdown voltage to set charged carriers free, which in turn creates electrical current that varies according to the amount of light impinging on the sensor. By measuring the electrical current generated by the light sensor, the amount of light impinging on, and thus ‘sensed’, or detected by, the light sensor may be derived.

### SUMMARY

A LIDAR system may include at least one mirror for projecting at least one burst of light at a predetermined point, or in a predetermined direction, during a scan period wherein the predetermined point is determined by a controller. A camera, coupled to the controller, captures images at a rate of an adjustable predetermine number of frames per second with each of the predetermined frames corresponding to an open-aperture period during which the camera captures light reflected from a scene it is focused on. The camera may have an adjustable predetermined angular field of view. The LIDAR system and camera may be substantially angularly-synchronized such that the controller directs at least one mirror to aim at least one burst of light at a point, or in a direction, within the angular filed of view of the camera and wherein the LIDAR system and camera are substantially time-synchronized such that the controller directs the LIDAR system to emit, or project, the at least one burst of light substantially during an open-aperture period of camera. The controller manages the angular and temporal synchronization between the LIDAR system and the camera.

The controller may direct the LIDAR system to project multiple bursts of light at a different point, or points, or in a different direction, or directions, during the scan period, wherein each point to which, or direction in which, a burst is directed is within a current field of view of the camera.

The controller may be configured to cause an image detection application to analyze one or more objects corresponding to the point at which, or direction in which, a light burst is directed by analyzing a light-burst portion of the image represented by pixels that are within a predetermined image-evaluation range of the point at which, or direction in which, a given burst of light is directed for purposes of determining characteristics and the nature of the object. A predetermined number of pixels of the image may define an image-evaluation range, or size. The predetermined number of pixels may also define a particular shape of the image-evaluation range.

The controller may be configured to cause the LIDAR system to determine at least one distance to the one or more objects within the image-evaluation range corresponding to the point at which, or direction in which, a light burst is directed.

The controller may cause an application that is running on the controller, or that may be running on another controller/computer device and that may be accessed or controlled by the first controller, to determine whether to generate a take-action message based on the nature of the object, or objects, in the image-evaluation range, and based on the distance to the object, or objects in the image-evaluation range.

### BRIEF DESCRIPTION OF THE DRAWINGS

FIG. 1 illustrates an autonomous vehicle in an environment with foreign objects in the road ahead.

FIG. 2 illustrates a sensor pod having a camera and a LIDAR light transmitter/receiver.

FIG. 3 illustrates aerial views of a vehicle in an environment with a foreign object in the road ahead during different image frames captured during different open-aperture periods.

FIG. 4 illustrates three image frames with each showing the position of the direction of a light burst relative to the position of a foreign object during a scan period that corresponds to a camera open-aperture period.

FIG. 5 illustrates an image of a foreign object captured by a camera during an open-aperture period with a grid overlay that represents pixels of the image.

FIG. 5A illustrates an image of a foreign object captured by a camera during an open-aperture period with a grid overlay that represents pixels of the image with a circular image-evaluation range centered at a anchor pixel of the foreign object representation.

FIG. 5B illustrates an image of a foreign object captured by a camera during an open-aperture period with a grid overlay that represents pixels of the image with a rectangular image-evaluation range beginning at an anchor pixel of the foreign object representation.

FIG. 6 illustrates a flow diagram of a method for synchronizing the capturing of an image and determining that a light burst was reflected from an object in the image.

FIG. 7 illustrates a flow diagram of a method for evaluating a portion of an image corresponding to a reflected light pulse.

### DETAILED DESCRIPTION

As a preliminary matter, it will be readily understood by those persons skilled in the art that the present invention is susceptible of broad utility and application. Many methods, aspects, embodiments, and adaptations of the present invention other than those herein described, as well as many variations, modifications, and equivalent arrangements, will be apparent from, or reasonably suggested by, the substance or scope of the described aspects.

Accordingly, while the present invention has been described herein in detail in relation to preferred embodiments and aspects, it is to be understood that this disclosure is only illustrative and exemplary of the present invention and is made merely for the purposes of providing a full and enabling disclosure of the invention. The following disclosure is not intended nor is to be construed to limit the present invention or otherwise exclude any such other embodiments, adaptations, variations, modifications and equivalent arrangements, the present invention being limited only by the claims appended hereto and the equivalents thereof.

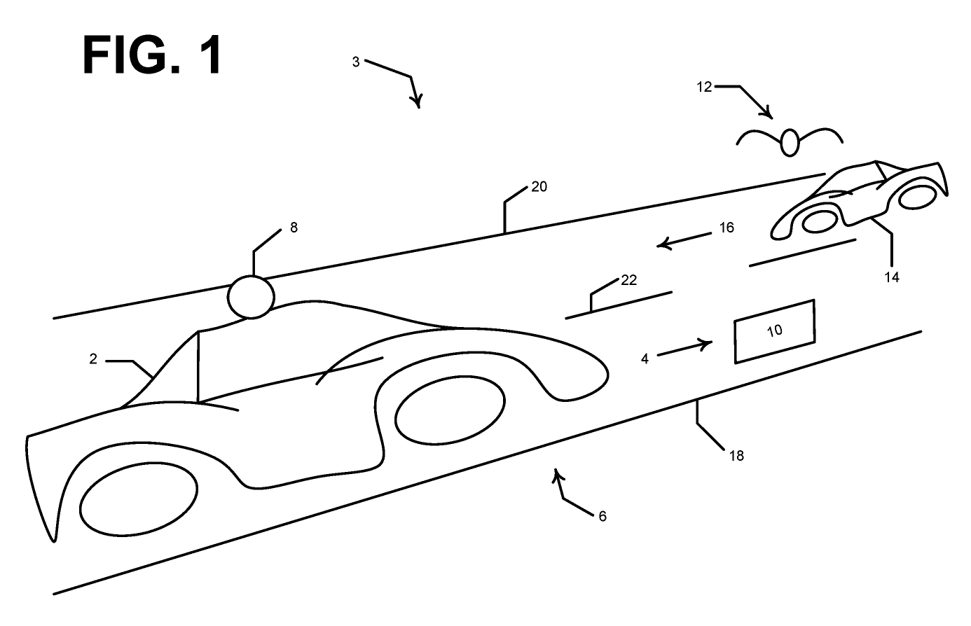

Turning now to the figures, FIG. 1 illustrates an autonomous vehicle 2 traveling in direction 4 in an environment 3 with foreign objects lying in the road 6 ahead. Vehicle 2 includes a sensor pod 8, that may include sensors such as: one or more camera, some or all of which may be still cameras or video cameras, a LIDAR transmit/receive system, temperature detectors, magnetic detectors for detecting large ferrous object such as another vehicle, proximate to vehicle 2, a RADAR system, ultrasound transmit and receive sensors, microphone, a rain sensors, a barometric pressure sensor, and other sensors that may be useful when mounted externally to an autonomous vehicle. It will be appreciated that pod 8 is shown in the figure on the roof of vehicle 2 for purposes of clarity, because of the advantage of being above the vehicle to provide 360 degree detection of conditions corresponding to the sensors it contains. However, one or more pods similar to pod 8 could be mounted in front of vehicle 2, on either or both sides of the vehicle, aft of the vehicle, underneath the vehicle, inside the vehicle behind the windshield, or wherever else may provide an advantage of increased sensitivity to conditions corresponding to parameters given sensors in the pod are configured to detect. In addition, pod 8, or other similar pods, may include all of, or fewer than, the sensors listed, supra. Furthermore, pod 8 may be very streamlined compared to the illustrated pod 8, and may be incorporated into the bodywork of vehicle 2 to improve aesthetics and aerodynamics.

As shown in FIG. 1, as vehicle 2 travels in direction 4, it will encounter foreign objects in the road such as item 10, perhaps bird 12, or another vehicle 14. Other vehicle 14 is shown traveling in the opposite direction 16 and in the lane for opposing traffic flow, but the other vehicle could also be in the same lane as autonomous vehicle 2, and could be traveling in the same directing as the autonomous vehicle 2 but at a lower rate of speed. FIG. 1 also shows lane edge markers/stripes 18 and 20, and center lane marker/stripes 22. It will be appreciated that although vehicle 2 is described in reference to FIG. 1 as an autonomous vehicle, the term autonomous vehicle can mean degrees of autonomy that vary across a spectrum that may range between 100% autonomy, where the autonomous vehicle, and back end computers that it may communicate with wirelessly via a communication network, determine operational parameters such as steering angle, braking force, acceleration force, horn, headlight, windshield wiper, and turn signal operation at one end of the spectrum, and zero percent autonomy, where a driver controls the vehicle, but may rely on warnings generated by the vehicle or backend computers, that are generated based on conditions that may be detected by sensors in pod or, or sensors that are installed or located elsewhere in the vehicle, such as accelerometers, gyroscopes, pressure sensors, compass, magnetic field detection sensors, microphones, cameras, etc. that may be permanently manufactured as part of the vehicle that are coupled to a communication bus of the vehicle, that may be part of a dongle that plugs into a port that communicates with a communication bus of the vehicle, such as an OBD-II port or similar, or that may be part of a user's device, such as a smart phone, tablet, smart watch, laptop, wearable such as a pendant around the neck or a device clipped on to an article of clothing such as a belt or pocket.

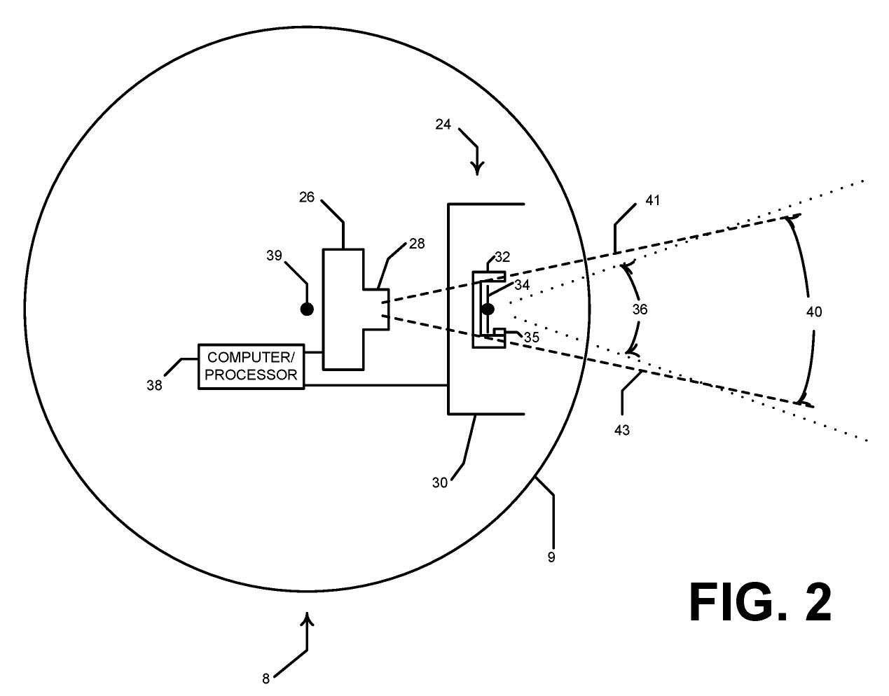

Turning now to FIG. 2, the figure illustrates an aerial view of two sensors in pod 8, LIDAR system 24 and a camera 26, which includes a lens 28. LIDAR system 24 includes a housing 30, and light emitting portion 32. Controllably movable mirror 34 may direct, or projects, bursts of light from a light sources 35 of the LIDAR system in a predetermined direction within arc 36 as determined by controller 38. It will be appreciated that controller 38 may be a microprocessor and supporting circuitry and may be incorporated into pod 8. Controller 38 may include one or more applications running on one or more microprocessors. Alternatively, controller 38 shown in the figure may represent an interface for receiving computer instructions from the vehicle via a wired Controller Area Network (“CAN”), or for receiving instructions via a wireless link, such as a Wi-Fi, or similar, link from an electronic control module of the vehicle, or from a user's device, such as a smart phone, or other devices as discussed supra.

Regardless of the style or location of controller 38, the controller is coupled to camera 26 and LIDAR system 24, either via wired or wireless link, and may coordinate the orientation or mirror 34, pulse rate of light source 35, and frame rate of the camera. Camera 26 and LIDAR system 24 may be mounted to a frame so that they are continuously rotatable up to 360 degrees about axis 39 of pod 8. In addition, each of camera 26 and LIDAR system 24 may be separately rotatable about axis 39; for example camera 26 could remain focused straight ahead as vehicle travels in direction 4, while LIDAR system rotates about axis 39. Or, camera 26 could rotate while LIDAR system 24 remains pointed ahead in the direction of vehicle travel (or whichever way the sensor pod is oriented as a default, which could be different than direction 4 if the pod is mounted on the sides or rear of the vehicle.

However, a mounting frame may fix camera 26 and LIDAR system 24 so that lens 28 and housing 32 are focused and pointed in vehicle travel direction 4. In such a scenario, controller 38 may control mirror 34 so that its arc of travel 36, or the arc over which a light burst is projected from LIDAR system 24, substantially corresponds to the field of view angle 40 of camera 26, which may vary based on the focal length of lens 28. It will be appreciated that arc 36 and field of view 40 may not have exactly parallel bounds because a light sensor of camera 26 and mirror 34 are not located at exactly the same point left-to-right as viewed in the figure, but controller 38 may be configured to mathematically account for variation between the field of view of the camera and the arc over which the LIDAR system may project light bursts. Furthermore, controller 38 may account for differences in location that are greater than shown in the figure. For example, camera 26 and LIDAR system 24 may not be collocated in POD 8; LIDAR may be mounted in the pod but the camera may be mounted elsewhere on vehicle 2. Lens 28 may be an optically zoomable lens that may be zoomed based on instructions from controller 38. Or, camera 26 may be digitally zoomable, also based on instructions from controller 38. If the focal length of camera 26 increases, field of view angle 40 would typically decrease, and thus controller 28 may correspondingly decrease oscillation arc 36 which mirror 34 may traverse. If the focal length of camera 26 decreases, field of view angle 40 would typically increase, and thus controller 28 may correspondingly increase oscillation arc 36 which mirror 34 may traverse.

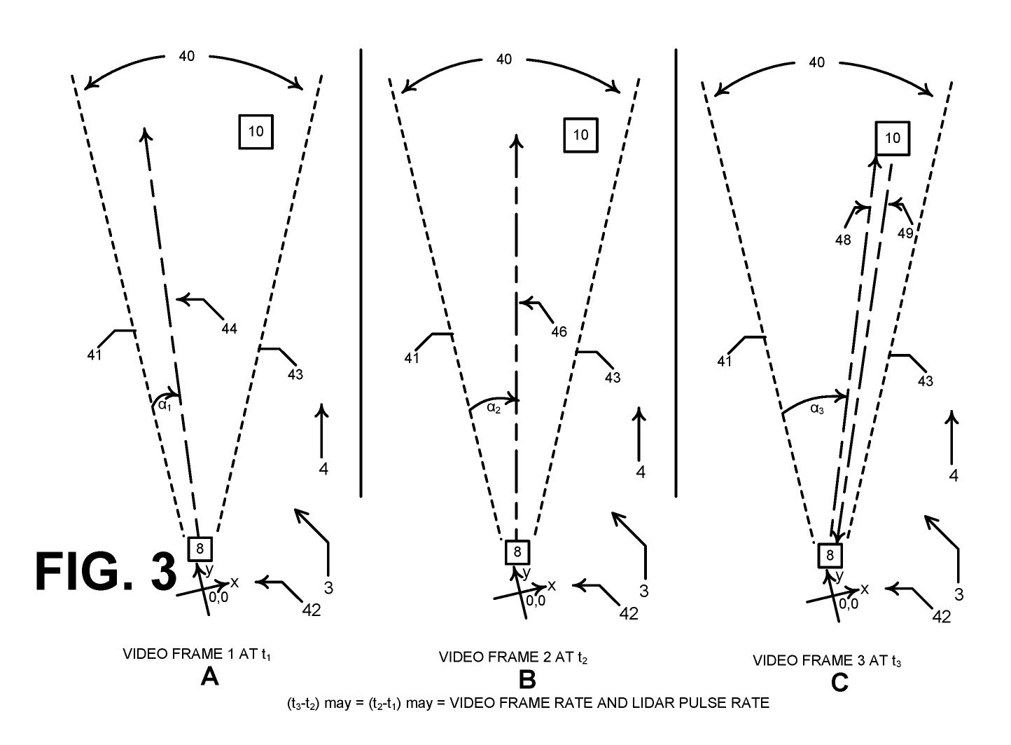

Turning now to FIG. 3, the figure illustrates part of environment 3 from FIG. 1 with autonomous vehicle 2 (not shown in FIG. 3 for clarity) at three successive points A, B, and C. Points A, B, and C correspond to times t₁, t₂, and t₃, respectively, where t₃>t₂>t₁ and which occur during a trip while the autonomous vehicle travels in direction 4 with object 10 lying in the road ahead as shown in FIG. 1. FIG. 3 shows coordinate system 42 having its y-axis parallel to the left-most boundary 41 of field-of-view 40 of camera 26, which is part of pod 8 as described supra. Left-most boundary 41 of field-of-view 40 is chosen as the reference angle of the field of view, which left boundary may also be the reference angle of arc 36, which mirror 34, and thus sequential bursts of light reflected from it, may traverse from left boundary 41 to right boundary 43. It will be appreciated that left boundary 41 is chosen as the reference boundary for purposes of discussing a direction of a burst of light from LIDAR system 24, and that mirror 36 may traverse from right boundary 43 to left boundary 41, instead of from left to right. Typically, mirror 36 will oscillate back-and-forth between left boundary 41 and right boundary 43 while reflecting bursts of light emanating from light source 35 of LIDAR system 24 at a predetermined LIDAR light pulse rate (“LPR”).

Controller 38 of sensor pod 8 may synchronize the LPR with a video image frame rate of camera 26, which, along with LIDAR system 24, are part of the sensor pod as described in reference to FIG. 1, supra, but which are not shown in the illustration of the sensor pod in FIG. 3. At point A (time=t₁) mirror 34 has traversed arc 36 α₁ degrees from left boundary 41, and controller 38 causes light source 35 to direct a burst of light at the mirror. The burst of light is reflected from mirror 34 along direction 44. Substantially simultaneously at t₁, controller 38 causes camera 26 to capture an image of its field of view 40, which corresponds to an angular field between left boundary 41 and right boundary 43. Alternatively, camera 26 may operate at a predetermined frame rate, and the camera may provide a trigger signal, based on its independently operating frame rate, to controller 38, which may instruct light source 35 to emit a burst of light toward mirror 34 at t₁ based on the trigger signal. As shown in the figure, the light burst along direction 44 misses object 10 to the left of the object, so no reflection of the light burst at point A is received back at the LIDAR system of pod 8.

Similarly, at point B, which occurs at time=t₂, mirror 34 has traversed arc 36 α₂ degrees from left boundary 41, (α₂>α₁) and controller 38 causes light source 35 to direct a burst of light at the mirror along direction 46. Substantially simultaneously at t₂, controller 38 causes camera 26 to capture an image of its field of view 40. As shown in the figure, the light burst along direction 46 misses object 10 to the left of the object, so no reflection of the light burst of point B is received back at the LIDAR system of pod 8.

Similarly, at point C, which occurs at time=t3, mirror 34 has traversed arc 36 α₃ degrees from left boundary 41, (α₃>α₂>α₁) and controller 38 causes light source 35 to direct a burst of light at the mirror along direction 48. Substantially simultaneously at t3, controller 38 causes camera 26 to capture an image of its field of view 40. However, unlike in the illustrations of point A and point B, the light burst along direction 48 hits at least a corner or edge of object 10, and at least some energy of the light burst of point C is reflected from object 10 and is received back at the LIDAR system of pod 8 along direction 49. Thus, in three successive image frames captured by camera 26, LIDAR light bursts were not reflected form object 10 from light burst of points A and B, but the image captured of the scenario existing at point C corresponds to LIDAR system 24 receiving a reflection of light from the burst that occurred at t₃. When controller receives a signal, or message, from LIDAR system 24, it may perform, or cause the performance of, an evaluation of the image from camera 26 corresponding to the scenario that existed at point C.

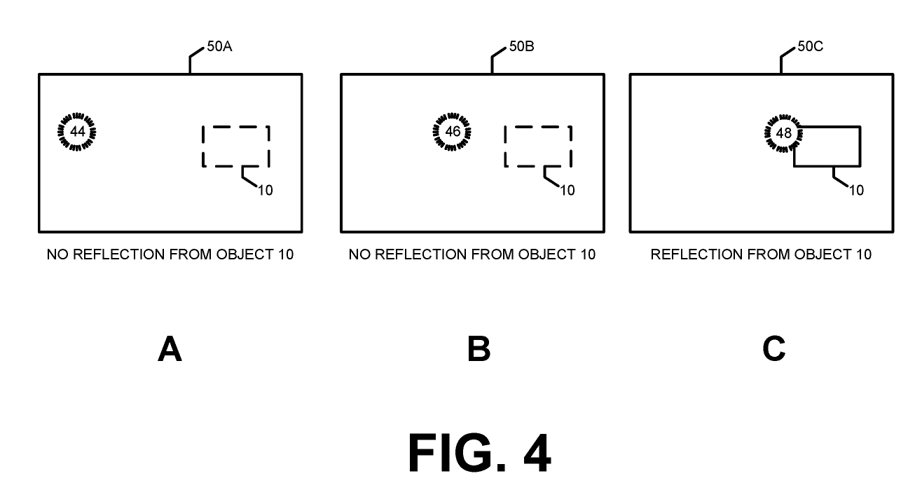

Turning now to FIG. 4, the figure illustrates three images 50A, 50B, and 50C, which correspond to times t₁, t₂, and t₃, respectively as described in connection with FIG. 3, supra. Image 50A shows a light burst portion 44 to the left of object 10, wherein light burst portion 44 represents the burst of light that was directed along direction 44 shown in FIG. 3. Object 10 is shown in dashed lines to indicate that it did not reflect light from the light burst 44. Image 50B shows, to the left of object 10, light burst portion 46 that represents the burst of light that was directed along direction 46 in FIG. 3. Object 10 is shown in dashed lines to indicate that it did not reflect light from the light burst. Although shown to the left of object 10, light burst position 46 is closer to object 10 than the position of light burst 44 shown in image 50A as a result of α₂ being greater than α₁ as shown in FIG. 3. In image 50C shown in FIG. 4, light burst portion 48 is shown overlaying a corner and edges of object 10, which happens as a result of α₃ being greater than α₂ and light burst 48 impinging on at least a portion of object 10.

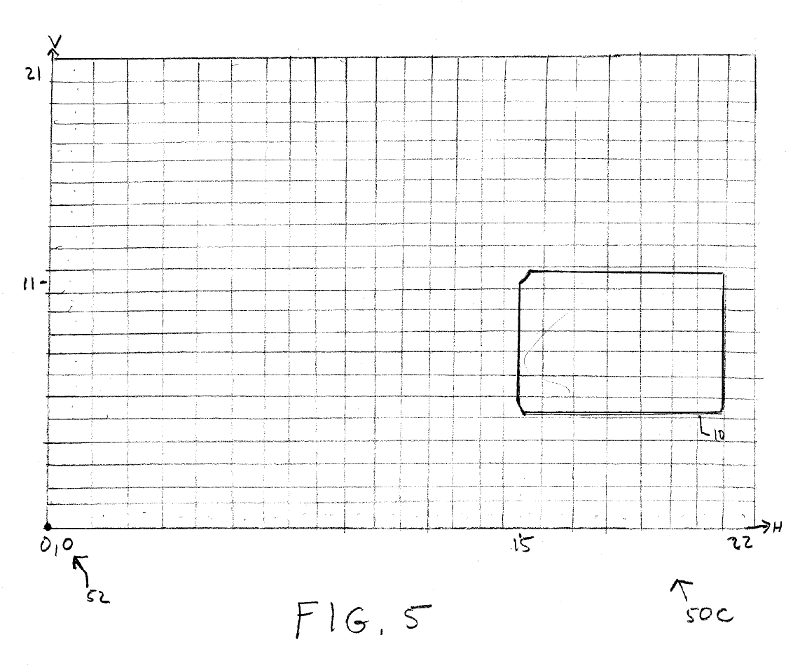

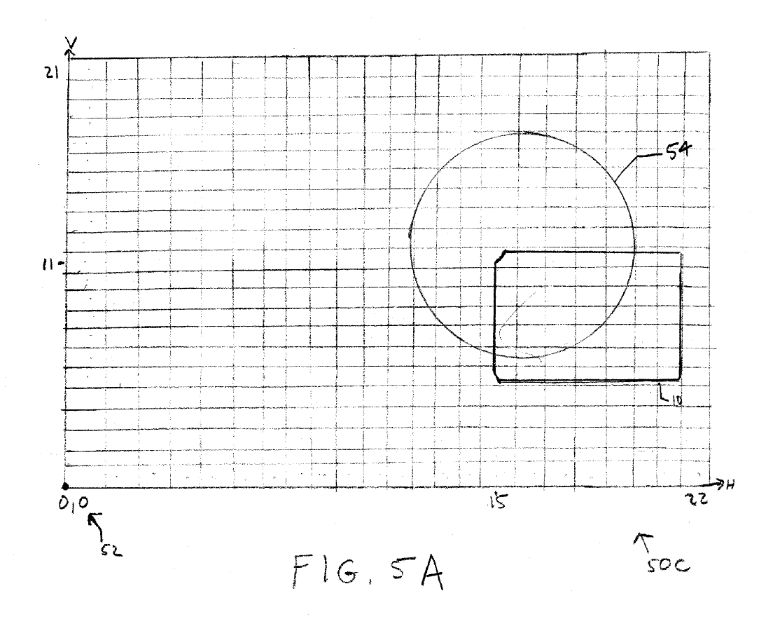

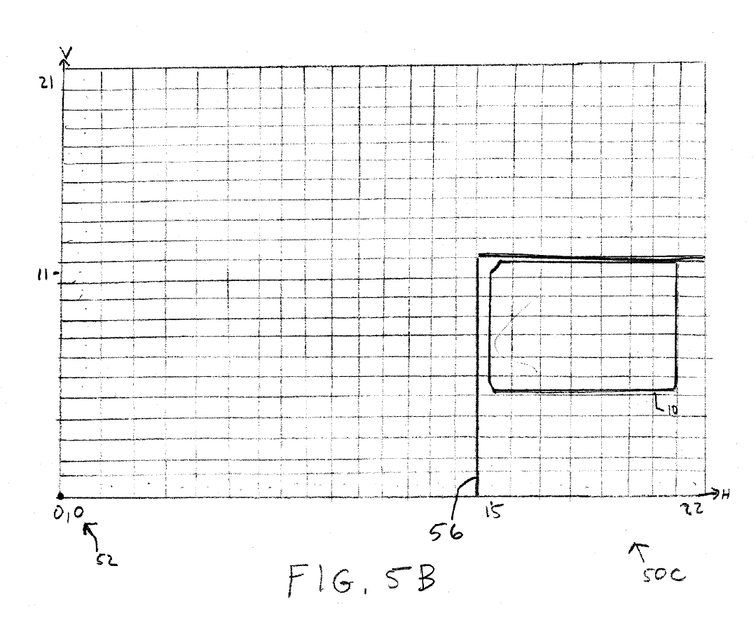

As discussed above in reference to FIG. 3, when LIDAR system 24 received a reflection of a light burst along direction 49, controller 38 may have determined that further evaluation of image C should be performed. In FIG. 5, a representation of image 50C is shown with a grid overlaying the image and with a coordinate system having an origin 52. The rectangular elements of image 50C represent pixels of the image. For reference, the pixels are numbered from origin 52 (the lowermost pixel in the left hand column is pixel 0, 0), and compose a grid of pixels having 22 rows and 23 columns.

Because controller 38 synchronized/managed the producing of light bursts from LIDAR system 24 with the frame rate of camera 39, and because the controller tracks the direction of the light burst, the controller can determine to perform image recognition on only a portion of image 50C. The controller may make a determination to only evaluate the right portion of the image 40 based on the lack of reflections from bursts that were directed along directions 44 and 46. It will be appreciated that controller 38 may determine not to evaluate any portion of image 50C, even though object 10 reflected some of the burst that was directed along direction 48 based on a strength of the signal reflected back along direction 49 being below a predetermined reflected signal strength predetermined threshold, or if the time of arrival of the signal reflected along direction 49 is longer than a predetermined time/distance threshold, thus indicating that the distance from pod 8 to object 10 is far enough such that consuming of processing resources to perform image recognition/evaluation can be conserved and can wait until future light bursts are reflected from object 10 if signal strength or time delay of the reflected light burst exceeds their corresponding thresholds.

Turning now to FIG. 5A, the figure illustrates image 50C with a circular image evaluation range 54 center approximately at 15, 11 (i.e., the pixel that is sixteen pixels horizontally from origin 52 and twelve pixels vertically from the origin). Controller 38 may determine that when LIDAR system 24 receives a reflection of at least some energy from the light burst emitted at t₃, then a region of, or portion of, image 50C that contains pixels representing environment 1 roughly in the vicinity of the direction of the light burst at t₃ (i.e., direction 48 in FIG. 3), should be evaluated to determine the nature of the object. Controller 38 may instruct image recognition soft running on a device that is part of the controller, coupled to the controller, that is part of vehicle 2, that is part of a device associated with vehicle 2, such as a user's smart phone, or a remote computer server that is in communication with the vehicle, smart phone, controller, or sensors that compose the vehicle or smart phone, to analyze the pixels of image 50C that correspond to a portion of field of view 40 that corresponds to the direction the burst of light was directed along when the image was captured, which in the instance of image 50C a portion in the right third of the image corresponds to the burst direction 48 and reflection direction 49.

To perform image recognition/image evaluation/computerized ‘vision,’ controller 38 may direct image recognition/evaluation/vision software to evaluate only certain pixels of image 50C based on a predetermined image evaluation range that correspond to the portion, or region, of the image that maps to the direction within field of view 40 that produced a reflection of a light burst that was sent substantially during the open aperture period when camera 26 captured image 50C. As shown in FIG. 5A, image evaluation range 54 is a range of pixels that form a circle substantially around the corner, or edges that produced a reflection from object 10. In this aspect where image evaluation range 54 pixels form a circle, the center pixel of the circle may correspond to a horizontal number of pixels from origin 52 that map to the angle α₃ of direction 48 relative to the reference y-axis of reference coordinate system 42 shown in FIG. 3. Since controller 38 did not receive reflections from light bursts emitted from LIDAR system 24 at times t₁ or t₂, controller may determine to conserve computer resources, such as processing, memory, storage, communication network messaging resources, etc. and only process pixels within the image evaluation range. Or, processor 38 may determine that all pixels that have a similar intensity or color saturation as pixels within evaluation range 54, even if they do not fall within the evaluation range, are part of the same object and should be processed together with the pixels within the evaluation range that exhibit the similar luminous and color characteristics.

Upon processing the pixels within, and/or proximate the pixels within, image evaluation range 54, to determine the nature of the object that caused a reflection of the light burst along direction 48 that was emitted from LIDAR system 24 at t₃, controller 38 may make a determination, or an application running on the controller or a device (i.e., vehicle device or user's smart phone) in communication with the controller, may cause the generation of a take-action message based on the nature of the object, or objects, represented by pixels in or proximate the image-evaluation range, and based on the distance to the object, or objects represented by the pixels in or proximate the image-evaluation range. For example, if image processing ‘vision’ software/application determines that object 10 in image 50C is a tire, controller 38 may generate a take-action message to cause vehicle 2 to perform braking or steering operations to avoiding colliding with the object. But, if controller 38 determines that object 10 is a soft object, like a piece of foam, paper, or cardboard, the controller may generate a take-action message to cause vehicle 2 to take perform a different action, such as only apply brakes, especially if another vehicle had been detected upon evaluation of pixel in an image evaluation range of the left portion of an whether image 50C or a previously evaluated image. Such a determination of another vehicle in the left portion of an image may indicate an oncoming vehicle 14 on a two-lane road 8 such as shown in FIG. 1. Controller 38 may also determine that no action should be taken by vehicle 2 if, for example, another vehicle 14 has been detected in a portion of an image and if the controller has determined that another vehicle has been following vehicle 2. (Sudden application of brakes by vehicle 2 could result in more damage if the following car ‘rear-ends’ vehicle 2 than if vehicle 2 collided with the soft object.) In another scenario, if image recognition/vision software determines that pixels corresponding to a reflection of a given light burst that are within, or proximate, an image evaluation range, is a fleeting object, such as a bird, controller 38 may withhold sending a take-action message to the vehicle until future images that may be taken by camera 26 that correspond to bursts of light at future times t₄-t_{N} have been evaluated to determine whether the fleeting object may still be ahead of vehicle 2, and thus whether a need exists to perform an action that changes current operation of the vehicle (change in braking, steering, acceleration, etc.).

Turning now to FIG. 5B, the figure illustrates image 50C with a rectangular image evaluation range 56 with a beginning pixel 15, 11. The beginning pixel that is sixteen pixels horizontally from origin 52 and twelve pixels vertically from the origin represents a portion of object 10 that would have likely caused a reflection of the light burst at t₃ along direction 48 shown in FIG. 3 as LIDAR mirror 34 oscillates away from left boundary 41 along arc 36 toward right boundary 42, as shown in FIG. 2.

It will be appreciated that an anchor pixel (i.e., the center pixel of a circular pixel range, a corner of a rectangular range, and edge pixel of a rectangular range, a foci of an ellipse, parabola, or hyperbola, etc.) that anchors an image evaluation range may depend on the direction of the sweep along arc 35, An anchor pixel, as well as an evaluation range shape, may be selected (i.e., automatically by controller 38, or manually by user input via a user interface of a smart phone, or computer device in communication with controller 38, which may be remote form vehicle 2) or predetermined (i.e., preprogrammed into an application running on, or accessible by, controller 38), based on previously determined objects from image evaluation of image frames corresponding to previous bursts of light from LIDAR system 24, and the anchor point may be any pixel of a given range shape. The anchor pixel may be a pixel that is not the center of a circle, or that is not the foci of an ellipse, parabola, and hyperbola.

In addition, it will be appreciated that the movement of LIDAR mirror 34 has been described for purposes of simplicity in describing the drawings as moving from left to right, corresponding to left and right of vehicular movement direction 4 shown in FIG. 1, but the LIDAR mirror may also move up and down, or in any other predetermined motion pattern, such as circular, zig-zag, parabolic, hyperbolic, etc. Controller 38 may choose a different motion pattern for LIDAR mirror 34 based on road conditions, weather conditions, traffic conditions, or surrounding environment. Mirror motion patterns may be selected (i.e., automatically by controller 38, or manually by user input via a user interface of a smart phone, or computer device in communication with controller 38, which may be remote form vehicle 2) or predetermined (i.e., preprogrammed into an application running on, or accessible by, controller 38), to optimize detection of objects, road hazards, animals, and pedestrians that the controller or controller application may deem likely to manifest themselves based on current conditions of an environment the vehicle is surrounded by.

Controller 38 may also adjust image frame rate of camera 26 and the synchronized light burst rate from LIDAR 24 according to conditions. For example, if environment 3 in FIG. 1 that autonomous vehicle 2 travels in comprises long stretches of straight roadway in the Southwestern United States, where traffic is light and with little debris along roadway 6 (which could be based on multiple evaluations of previous images from camera 24), controller 38 may select a low camera frame rate and a corresponding low light burst rate, along with a slow, oscillating sweep of mirror 34 along arc 35, based on an assumption, or analysis of previous images, that few, or no, foreign objects have been detected along roadway 6 for a predetermined distance traveled. In an aspect, even if foreign object have been previously detected, and one or more take-action messages have been generated, if roadway 6 is straight for a predetermined distance ahead, which road straightness could be determined from input from mapping or navigation systems, controller 38 may determine that lower synchronized frame and bursts rates, slow mirror track speed (i.e., the angular speed that mirror 34 traverses arc 35), or simple mirror motion pattern (i.e., simple oscillation between left and right boundaries 41 and 42) will provide adequate detection of foreign objects that vehicle 2 may encounter and need to take action to avoid based on one or more take action messages generated by the controller. On the other hand, if many foreign objects have been detected, traffic is heavy (which determination could be based on traffic information received by the vehicle, a user's smart phone, a navigation system, or from evaluation of previously analyzed image), or if road 6 is not straight ahead for more than a predetermined straightness threshold, controller 38 may increase the synchronized camera frame rate and light burst rate, may increase the mirror track speed, or may change the mirror track motion pattern to a complex pattern that is optimized according to previously detected road environment conditions, or according to predicted conditions, which prediction may be made based on previously detected road environment conditions.

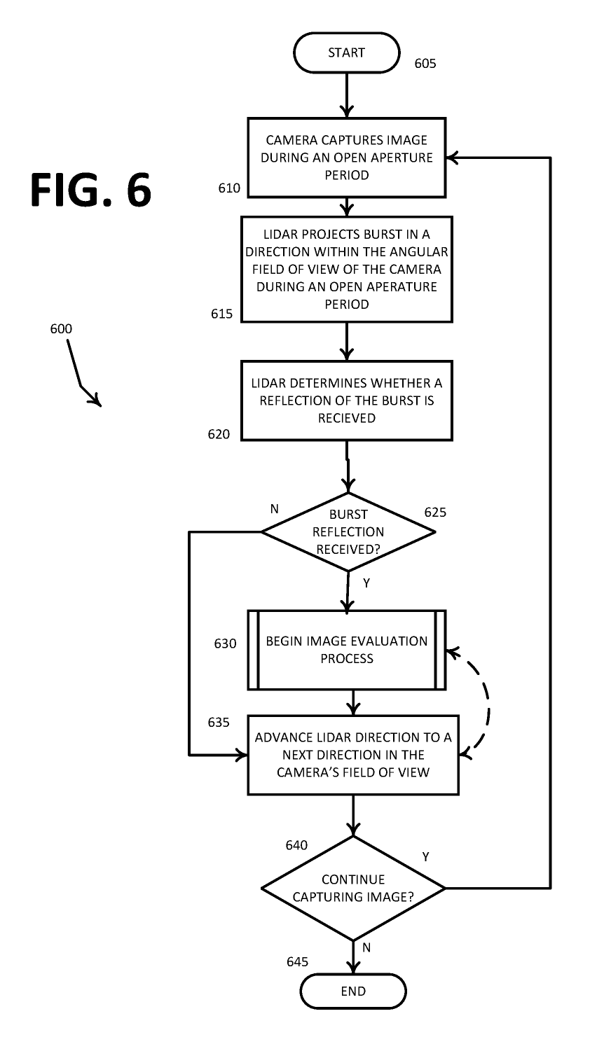

Turning now to FIG. 6, the figure illustrates a flow diagram of a method 600 evaluating a portion of an image corresponding to a reflected light pulse. Method 600 begins at step 605 and advances to step 610 where a camera that may be part of a sensor pod mounted to, or integrated with, a vehicle captures an image. The camera typically captures an image during an open aperture period. The camera may take a single still image during the open aperture period, or the camera may capture multiple images during corresponding multiple open aperture periods that may occur at a predetermined frame rate, such as may occur when a camera captures video content. A camera that capture video images typically captures the multiple images at a consistent frame rate, which may be 30 frames per second (“fps”), 60 fps, 24 fps, 48 fps, or any other rate that may be appropriate for a given situation or context.

At step 615, a LIDAR system that may be part of a sensor pod of the vehicle (perhaps the same sensor pod that includes the camera or perhaps a different pod) may emit a burst of light during an open aperture of the camera. The LIDAR system may emit multiple burst during multiple open aperture periods of the camera. Each of the multiple bursts may occur during each successive open aperture period of the camera such that the burst rate and the camera frame rate are substantially the same. Or, the burst may occur more or less frequently than the frame rate of the camera. The burst rate may be a multiple of the camera frame rate, which multiple may be a fraction less than 1. In an aspect, the multiple is 1 (i.e., the frame rate of the camera and burst rate of the LIDAR system are the same. In an aspect, the LIDAR burst rate is a fraction of 1. In an aspect, the burst rate fraction of 1 has a denominator that is an even divisor of the frame rate of the camera (i.e., no remainder if the even divisor is divided into the camera's frame rate). In an aspect the burst rate multiple is an integer.

In an aspect, a controller manages the synchronization of burst rate and frame rate between the LIDAR system and the camera. The controller may be part of a sensor pod that includes either, or both of, the camera and LIDAR system. The controller may be a microprocessor and supporting circuitry, an application running on a computer system that includes a microprocessor, a remote computer system in communication with a controller that is in turn in communication with the camera and LIDAR, such as a remote computer server operated by a services provider and coupled with the vehicle via a long-range wireless link, such as provided by a cellular, LTE, or similar communication network system. The controller may also be provided by short range wireless links between vehicle communication systems that may communicate and otherwise interact with other vehicle communication systems of other vehicles that are within a predetermined proximity to a subject vehicle, which may function as a dynamically changing vehicle-to-vehicle mesh network. Actions of the controller may also be performed by a user devices and one or more applications running thereon, such as a smart phone or tablet that is proximate the vehicle, typically within the cabin of the vehicle while the vehicle is traveling, although the user device could be located elsewhere in or on the vehicle. In an aspect the user device may be connected via a wired connection to a communication bus of the vehicle, such as a CAN bus, or may be coupled wirelessly via a short range wireless link, such as a Wi-Fi link or a Bluetooth© link.

The LIDAR system may be configured such that it can only project a burst of light in a direction within a field of view of the camera. The field of view may be changed (i.e., narrowed or widened with a lens of the camera is zoomed in or out, respectively). The LIDAR system may be configured mechanically to project a burst only in a direction of the field of view of the camera. Such mechanical configuration may include stops, linkages that cause motor input to cause oscillation along one or more arcs within one or more given planes such that bursts are only directed within a nominal field of view of the camera. Links of the mechanical linkages may be automatically lengthened or shortened in concert with zooming of the camera lens such that a sweep of the LIDAR along an arc in a given plane, or in another predetermined path shape, maintains light bursts substantially within the field of view of the camera. The camera zoom, camera frame rate, LIDAR path of light burst projection, and LIDAR burst rate may be managed by a single controller, or my separate controllers that are in communication with each other.

At step 620, a controller in communication with the LIDAR system determines whether a reflection of energy from a given light burst has been received. The controller of the LIDAR system, or a controller in communication with the LIDAR system, either of which may be the controller that controls aspects of the camera and of the LIDAR system, may determine whether a reflection of light energy has been received substantially at a light detector of the LIDAR system. If a determination is made that a reflection has not been received, method 600 follows the ‘N’ path at step 625 and advances to step 635. At step 635, a controller in communication with the LIDAR system may instruct the LIDAR to move a mirror so that it will project a next light burst along a new direction than light was projected at the most recent iteration of step 615. At step 640, if a determination is made by a controller to capture more images, method 600 follows the ‘Y’ path to step 610, where the camera captures a next image and the LIDAR system projects a next burst along the new direction at step 615, where after the method continues as described above. If a determination is made at step 640 that further images are not to required, or that a pause in the capturing of images can be implemented, method 600 advances to step 645 and ends. (A pause could be implemented for reasons such as to conserve battery energy in an electric vehicle or when road conditions or traffic condition information indicate that a pause in the synchronized camera-image-capture-LIDAR-burst-in-the-camera-field-if-view operation can be tolerated for a predetermine pause period.)

Returning to discussion of 625, if a determination is made at a preceding iteration of step 620 that a reflection of burst energy from a preceding burst at step 615 was received, method 600 advances to step 630, and a controller instructs that evaluation of the image captured during the preceding iteration at step 610 that corresponds to the iteration of the determination of the reception of reflected light at step 620 that caused the advance from step 625 to step 630. It may be desirable to choose to perform step 635 before step 630 for various reasons, which may include ensuring that synchronicity between the camera frame rate and the LIDAR burst rate or direction are not held up while image processing begins, which may be a prudential programming practice if the burst rate and camera frame rate are the same or if the burst rate is slower than the frame rate but is a fraction within a predetermine burst rate to frame rate tolerance.

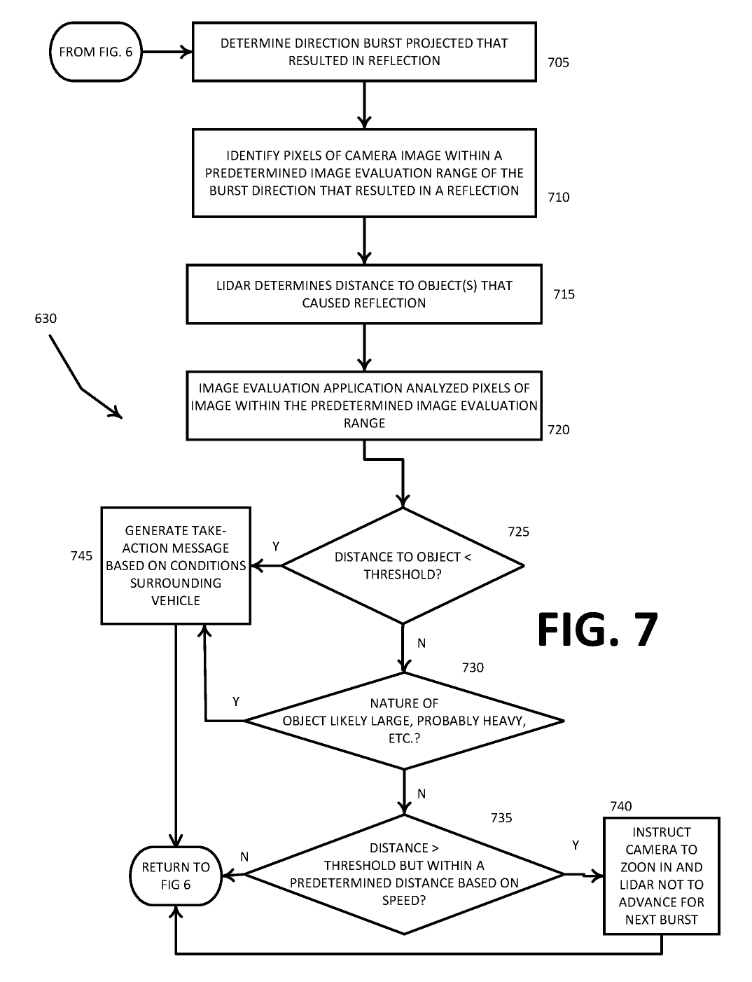

Turning now to FIG. 7, the figure illustrates a flow diagram of steps that may be performed when method 600 reaches step 630 in FIG. 6. Continuing with discussion of FIG. 7, when reflected energy from a light burst is detected, a determination is made at step 705 of the direction that a light burst that resulted in the reflection was projected along. A controller in communication with the LIDAR and the camera, may have caused synchronization relative to time and direction between the light burst and the corresponding aperture open period of the camera. Or, the controller may have simultaneously received aperture-open and light-burst-emitted message signals from both the camera and LIDAR, respectively, as well as a burst direction indication signal message from the LIDAR. Having access to the time that the camera captured an image and the time that the LIDAR emitted a corresponding light burst, for example a time stamp associated with the image from the camera and a time stamp message from the LIDAR system facilitates the controller at step 710 correlating pixels of a given stored image (typically stored in a memory that the controller can access) from the camera with an object that caused reflection based on the direction of the LIDAR system's light projecting mirror relative to the camera's field of view. The pixels of the image that correspond to the direction of the light burst may be referred to as being in an image evaluation range. At step 715, the LIDAR system may determine the distance to the object that caused the reflection the pixels in the image evaluation range represent.

At step 720, image evaluation software evaluates pixels within, or proximate, within a predetermine range or tolerance, the image evaluation range. The image evaluation software may be running on the controller, on a device in communication with the controller such as a vehicle electronic control module, a user's smart phone in a vehicle, or on a remote server (remote from a vehicle that is associated with the LIDAR system and camera) that is in communication with the controller. The image evaluation software may analyze the pixels to determine the nature of the object that reflected the light burst from the LIDAR when it was aimed in a direction that substantially corresponds to the image evaluation range. For example, the image evaluation software may determine that the pixels in the image evaluation range represent a stationary object such as a tire, or a dead animal in the road ahead. Or, the image evaluation software may determine that the pixels in the image evaluation range represent a moving object, such as an oncoming vehicle or a moving animal such as a deer. Such a determination may be based on analysis of previously captured and stored images that also included pixels that represent the same, or similar image, but wherein the image evaluation range comprises pixels at different coordinates. For example, in reference to the coordinate system shown in FIG. 5, the evaluation range in a current image may comprise pixels with a centroid to the left of the centroid of the image evaluation range in a previously acquired image, thus indicating that the object may be moving from right to left in the camera's field of view.

As discussed above, the LIDAR system may determine the distance to the object that caused the reflection, and that is represented by the pixels in the image evaluation range. If the distance to the object is less than a predetermined criterion, the controller may generate a take-action message at step 745. The predetermine criterion may be based on the speed that the vehicle is moving based on information the controller may have access to via a communication bus of the vehicle. The predetermined criterion may also be based on the speed of the moving object, which may be determined based on the time between image frames that were used to determine that an object is moving, which may be based on the frame rate of the camera. The take-action-message may include an instruction to the vehicle from the controller via the communication bus, such as a CAN bus, to apply brakes of the vehicle, alter the steered wheel position of the vehicle, accelerate in the direction of vehicle travel, sound a horn, or other vehicle operational actions that may be appropriate based on the distance to the object. After generating the take action message at step 745, method 600 returns to step 630 in FIG. 6. Returning to the description of FIG. 7, if the determination at step 725 is that the distance to the object represented by the pixels in the image evaluation range is not less that the predetermined criterion, a determination is made at step 730 whether the nature of the object is likely a large, heavy, or immovable object or a low-mass object that would not cause damage to the vehicle if the vehicle collided with it. For example, if the image evaluation application determines that the object represented by the pixels in the image evaluation range is a cardboard box, paper bag, etc., the nature of the object is such that an impact of the vehicle on it would not result in serious, or any, damage to the vehicle. On the other hand, if the image evaluation application determined that the nature of the object represented by the pixels in the image evaluation range is something like a log, a dead animal, a moving animal, or another vehicle, either moving or not, the object is such that an impact of the vehicle on it would likely result in serious damage to the vehicle and occupants therein. Thus, if the nature of the object represented by the pixels in the image evaluation range is deemed to be large, heavy, difficult to move, etc., subroutine 630 advances to step 745 and the controller may generate a take action message as described above and then return to step 630 shown in FIG. 6.

If the determination at step 730 is that the nature of nature of the object represented by the pixels in the image evaluation range is not heavy, large, or largely immovable, the controller may determine whether the distance to the object may be greater than or equal to the predetermined criterion discussed above in reference to step 725 but within a predetermined tolerance based on speed of the vehicle, speed of object movement, or both. If the determination is no, then subroutine 630 returns to step 630 shown in FIG. 6. If the distance to the object is determined to be greater than or equal to the predetermined criterion discussed above in reference to step 725 within a predetermined tolerance based on speed of the vehicle, then the controller may instruct the camera to zoom in in the direction of the most recent light burst that reflected energy from the object under evaluation, This may instruction may include an instruction for a pan-tilt mechanism that the camera is mounted to move such that when the camera zooms in, the object is still within the now-more-narrow field of view of the camera. The instruction may also include an instruction to the LIDAR system not to angularly advance horizontally, vertically, or both, so that the next image captured by the camera after the zoom-in action is performed, and after subroutine 630 returns to step 630 in FIG. 6, includes a LIDAR light burst projected at the object, the image of which should now have a greater pixel resolution representation of the object than in the previously captured image, which may result in improved accuracy in determining the nature of the object.

After return to step 630, method 600 advances to step 640 and determines whether to capture more images and synchronizing LIDAR lights bursts therewith. If the determination is yes, such as would be the case just described where the camera zoomed in on an object, the method 600 returns to step 610 and continues as described above. If the controller determines at step 640 that no more images are to be captured, which may be the case when a vehicle trip is complete, or if the vehicle is stopped for more than a predetermined period, method 600 ends at step 645.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents. Disclosure of particular hardware is given for purposes of example. In addition to the recitation above in reference to the figures that particular steps may be performed in alternative orders, as a general matter steps recited in the method claims below may be performed in a different order than presented in the claims and still be with the scope of the recited claims.

What is claims is:

1. A system, comprising:
a LIDAR system that includes at least one mirror or lens for projecting at least one burst of light in a predetermined direction, wherein the predetermined direction is determined by a controller;
a camera, coupled to the controller; wherein the camera captures images at a rate of an adjustable predetermine number of frames per second with each of the predetermined frames corresponding to an open-aperture period during which the camera captures light reflected from a scene it is focused on, and wherein the camera has an adjustable predetermined angular field of view;
wherein the LIDAR system and camera are substantially angularly-synchronized such that the controller directs the mirror to aim the at least one burst of light in a direction within the angular field of view of the camera and wherein the LIDAR system and camera are substantially time-synchronized such that the controller directs the LIDAR system to project the at least one burst of light substantially during an open-aperture period of camera; and
wherein the controller manages the angular and temporal synchronization between the LIDAR system and the camera.

2. The system of claim 1 wherein the controller directs the LIDAR system to project multiple bursts of light, wherein each light burst is directed in a different direction during a scan period, and wherein each direction in which a burst is directed lies within a current field of view of the camera.

3. The system of claim 2 wherein the controller is configured to cause an image detection application to analyze one or more objects corresponding to the direction at which a light burst is directed by analyzing a light-burst portion of the image that is within a predetermined image-evaluation range of the direction at which a given burst of light is directed to determine the nature of the object.

4. The system of claim 3 wherein a predetermined number of pixels of the image defines the image-evaluation range.

5. The system of claim 3 wherein the controller is configured to cause the LIDAR system to determine at least one distance to the one or more objects within the image-evaluation range corresponding to the direction at which a light burst is directed.

6. The system of claim 5 wherein the controller causes an application to determine whether to generate a take-action message based on the nature of the object, or objects, represented by pixels in, or proximate, the image-evaluation range.

7. The system of claim 5 wherein the controller causes an application to determine whether to generate a take-action message based on the nature of the object, or objects, represented by pixels in, or proximate, the image-evaluation range and based on the distance to the object, or objects represented by the pixels in, or proximate, the image-evaluation range

8. The system of claim 2 wherein the scan period is a period that a mirror of the LIDAR system traverses between a first boundary and a second boundary that defines an angular range that corresponds to the angular field of view of the camera.

9. The system of claim 8 wherein the boundaries that define the angular range lie in a plane parallel to a plane a vehicle moves in, wherein the camera and LIDAR system are components of a sensor pod that is mounted to the vehicle.

10. The system of claim 8 wherein the boundaries that define the angular range lie in a plane perpendicular to a plane a vehicle moves in, wherein the camera and LIDAR system are components of a sensor pod that is mounted to the vehicle.

11. A method, comprising:
projecting at least one burst of light in a predetermined direction from a LIDAR system;
capturing images with a camera at a rate of an adjustable predetermine number of frames per second wherein each captured image frame corresponds to an open-aperture period during which the camera captures light reflected from a scene it is focused on, and wherein the camera has an adjustable predetermined angular field of view;
wherein the LIDAR system and camera are substantially angularly-synchronized such that a mirror of the LIDAR system aims the at least one burst of light in a direction within the predetermined angular field of view of the camera and wherein the LIDAR system and camera are substantially time-synchronized such that the LIDAR system projects the at least one burst of light substantially during an open-aperture period of the camera; and
wherein a controller coupled to the LIDAR system and the camera manages the angular and temporal synchronization between the LIDAR system and the camera.

12. The method of claim 11 further comprising analyzing a light-burst portion of the image that comprises image pixels within a predetermined image-evaluation range of the direction at which the at least one burst of light is directed to determine the nature of an object represented by pixels within, or proximate, the predetermined image-evaluation range.

13. The method of claim 12 further comprising detecting energy reflected from the at least one burst of light before the analyzing of the light burst portion is performed.

14. The method of claim 12 further comprising determining whether to generate a take-action message based on the nature of, or distance to, the object, or objects, represented by pixels in, or proximate, the image-evaluation range.

15. The method of claim 14 further comprising determining at least one distance to the one or more objects within the image-evaluation range corresponding to the direction at which a light burst is directed, and further determining to generate a take-action message based on the at least on distance to the one or more objects within the image-evaluation range.

16. A controller to:
project at least one burst of light in a predetermined direction from a LIDAR system;
capture images with a camera at a rate of an adjustable predetermine number of frames per second wherein each captured image frame corresponds to an open-aperture period during which the camera captures light reflected from a scene it is focused on, and wherein the camera has an adjustable predetermined angular field of view;
wherein the LIDAR system and camera are substantially angularly-synchronized such that a mirror of the LIDAR system aims the at least one burst of light in a direction within the predetermined angular field of view of the camera and wherein the LIDAR system and camera are substantially time-synchronized such that the LIDAR system projects the at least one burst of light substantially during an open-aperture period of the camera; and
wherein a controller coupled to the LIDAR system and the camera manages the angular and temporal synchronization between the LIDAR system and the camera.

17. The controller of claim 16 further to analyze a light-burst portion of the image that comprises image pixels within a predetermined image-evaluation range of the direction at which the at least one burst of light is directed to determine the nature of an object represented by pixels within, or proximate, the predetermined image-evaluation range.

18. The controller of claim 17 further to detect energy reflected from the at least one burst of light before the analyzing of the light burst portion is performed.

19. The controller of claim 17 further to determine whether to generate a take-action message based on the nature of the object, or objects, represented by pixels in, or proximate, the image-evaluation range

20. The controller of claim 19 further to determine at least one distance to the one or more objects within the image-evaluation range corresponding to the direction at which a light burst is directed, and further to determine to generate a take-action message based on the at least on distance to the one or more objects within the image-evaluation range.
